(19) United States
(12) Patent Application Publication
(10) Pub. No.: US 2006/0260458 A1
(43) Pub. Date: Nov. 23, 2006

(54) Powered and ergonomically configured portable coping saw for one-handed use

(76) Inventor: Gary Friend, Commerce Township, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/134,933

(22) Filed: May 23, 2005

(51) Int. Cl. B23D 55/00

(52) U.S. Cl. 83/788

(57) ABSTRACT

A power saw suitable for one-handed operation having a three-dimensional shaped body with a hand grip and a base defining multi-sided exterior configuration. An electric motor is supported upon a mounting plate and installed within the housing. A gear drive system extends from an exposed face of the mounting plate and a power supply communicates to the motor and operatively drives the gear system. A continuous cutting band is supported upon outermost projecting gear members associated with the gear drive system, such that the band projects from a plurality of arcuately configured exterior surfaces associated with the body. A cutting zone is established at each projecting location of the band to perform a ripping operation on a workpiece positioned within a selected cutting zone.

### BACKGROUND OF THE INVENTION

1. Field of the Invention

The present invention is directed to a coping saw. More specifically, the present invention teaches a one-handed and ergonomically configured motorized coping saw exhibiting a looped cutting band driven by a planetary gear arrangement, and such as is particularly useful in cutting most available types of crown and baseboard moldings.

2. Description of the Prior Art

The process of coping has traditionally been completed with a coping saw. A traditional saw of this construction typically includes an elongated blade secured at opposite ends between a substantially “U” shaped frame defining a deep cutting throat, a handle extending from an end of the frame and which is capable of being grasped by a user for influencing reciprocating motion of the blade across a desired cutting workpiece surface (such as again in particular crown or baseboard moldings and the like).

Other attempts have been made to incorporate a spiral driven saw blade into a powered mechanism for providing faster and more effort-free cutting of a workpiece. A first example of this is set forth in U.S. Pat. No. 5,220,729, issued to Gallant, and which teaches a handheld power saw having a main housing and two guide housings telescopically interactive with the main housing and having facing open distal extremities. A motor and associated drive pulley are associated with the main housing. Paired idle and alignment rollers are disposed within the guide housings and an endless abrasive wire rope is centrally disposed within the main and guide housings in contact with the drive pulley and paired rollers. The region of the wire rope extending between the facing distal extremities of the guide housings is employed to cut a workpiece.

Nikisch, U.S. Pat. No. 3,621,894, teaches a spiral blade saw used as a hand or bench model and including a drive means for carrying a continuously winding spiral blade. As best shown in the opened view of FIGS. 2 and 3, the blade extends generally circumferentially within an enclosed interior of the associated housing, whereas a portion of the blade extending across an open section is substantially linear. U.S. Pat. No. 4,413,414, issued to Strzalka, teaches a handheld portable band saw also utilizing a similar array of rollers and with an open sawing location (see blade portion 16).

Cortez, U.S. Pat. No. 4,193,192, teaches a band saw device including a plurality of rollers defining a saw blade path, which is continuously arcuate except for a straight cutting section corresponding to a side opening formed in a body of the band saw device. A friction belt drive with associated guide rollers provides the motive force for the saw blade. Tension on the saw blade is adjusted by means of a pivotal roller carriage which is adjustable with respect to the main frame of the band saw with the roller carriage being horizontally adjustable with respect to the main frame.

A further series of powered saw designs, each of these utilizing a generally conventional coping saw configuration, are further illustrated in such references as Ward, U.S. Pat. No. 5,924,209 (WO 99/17900); Halsey, U.S. Pat. No. 5,388,334; and Roberts, U.S. Pat. No. 6,401,346. Additional examples of translating or cable saw assemblies are shown in Gates, U.S. Pat. No. 3,958,332 and Lofgren, U.S. Pat. No. 1,303,809. Another reference of note is Flagg, U.S. Pat. No. 6,282,793, and which teaches a coping saw attachment for a handheld power jig saw.

### SUMMARY OF THE PRESENT INVENTION

The present invention is an ergonomically configured and one-handed powered coping saw for ease of use in performing a ripping operation on a vast majority of existing molding types in single pass fashion. The saw includes a three-dimensional shaped body with a hand grip and a base defining multi-sided exterior configuration.

An electric motor is supported upon a mounting plate and installed within the housing. The motor is positioned within the body at a height and location approximate a center point defined by the cutting band and such that the motor sits above the gears and cutting band.

A gear drive system extends from an exposed face of the mounting plate. In a preferred embodiment, the gear drive system further includes a planetary drive system for communicating a power output of the motor to a plurality of perimeter defined gears.

A continuous cutting band is supported upon perimeter defined gears associated with the gear drive system, such that the band projects from a plurality of arcuately configured exterior surfaces associated with the body. A cutting zone is established at each projecting location of the band to perform a ripping operation on a workpiece positioned within a selected cutting zone. The blade direction of travel can further be made reversible by adding a “reversible switch” to the assembly. The coping saw may further incorporate an abrasive wire rope, such as which is suitable for cutting tile.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental view of the one-handed powered coping saw according to a preferred embodiment of the present invention;

FIG. 2 is a cutaway view taken along line 2-2 of FIG. 1 and showing the angled profile of the spiraling wire cutting band as it travels through the illustrated workpiece;

FIG. 3 is an exploded view of the powered coping saw according to the present invention; and

FIG. 4 is a bottom plan view of the coping saw, with the bottom cap disengaged, and illustrating an arrangement of interrelating gears for driving the cutting band according to the present invention.

### DETAILED DESCRIPTION OF THE PREFERRED EMBODIMENTS

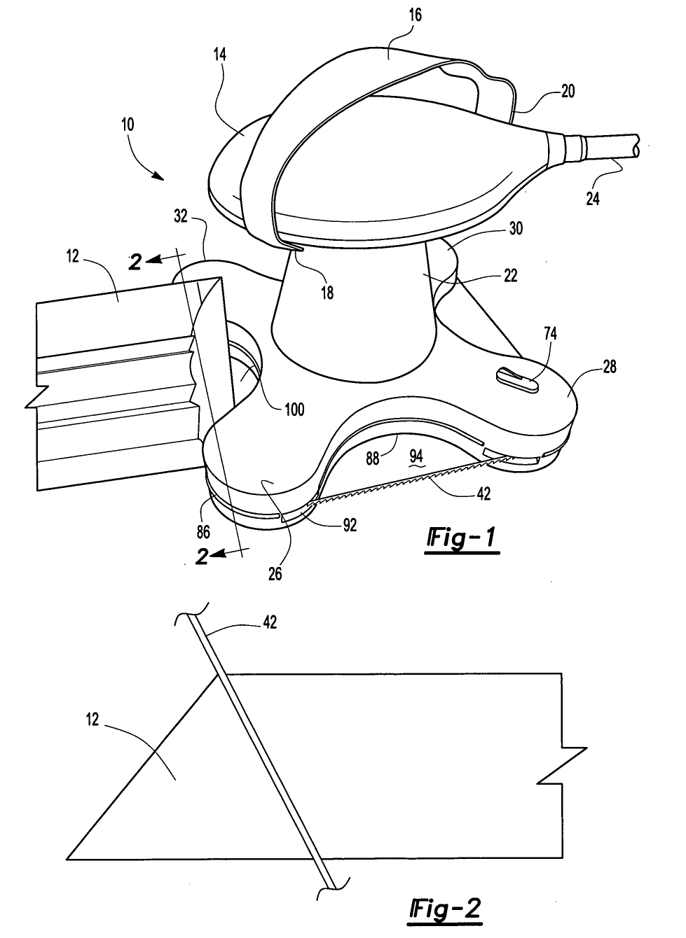

Referring now to the environmental view of FIG. 1, a portable and ergonomically configured and motorized coping saw is illustrated at 10 according to a preferred embodiment of the present invention. As previously described, the powered coping saw 10 is designed for easy one-handed use and in order to quickly and efficiently perform a ripping operation on a workpiece 12, such as a variety of crown and baseboard type moldings.

The saw 10 includes a body defined by an outer housing and including an uppermost palm-shaped grip 14, this typically shaped in ergonomic fashion and constructed of a non-slip rubber or other suitable material providing for ease of use by individuals with differently sized hands. Extending in overhead fashion above the palm grip 14 is an adjustable strap 16, connected at opposite ends 18 and 20 to underside locations of the palm grip 14 approximate to an intermediate extending annular portion 22 of the housing. A power cord 24 extends from the grip 14 in a fashion that it does not interfere with the subsequent manipulation and ripping operations associated with the saw 10. As will also be described subsequently, other forms of power input, such as portable batteries or power packs, can be utilized with the saw 10.

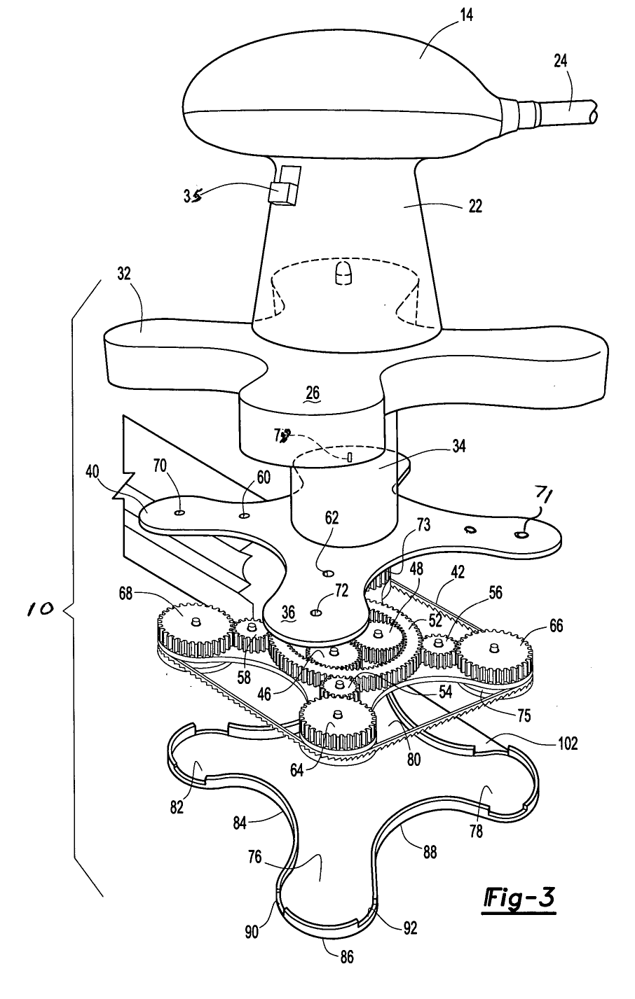

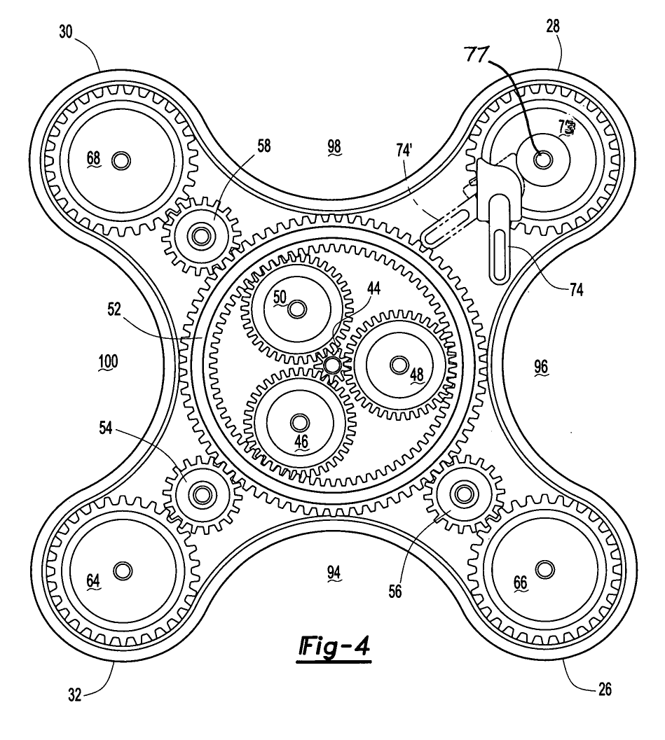

The housing further includes a base integrally connected to the annular extending portion 22, the base exhibiting a specified depth and including a plurality of four outwardly radially and arcuate extending portions 26, 28, 30 and 32. An electric motor, such as an AC motor (or DC motor in the instance of a battery/power pack) as is illustrated at 34 in FIG. 1, is supported upon a mounting plate configured with four outwardly extending arcuate portions generally corresponding in shape to the portions 26, 28, 30 and 32 associated with the outer housing base, see as illustrated by arcuate portions 36, 38 and 40 shown in FIG. 3 and which matingly engage the mounting plate within the lowermost and open housing.

A variable speed power switch is illustrated at 35 (see FIG. 3) accessible from an exterior surface of the housing's intermediate annular portion 22 and proximate an underside location of the palm grip 14, and which communicates an external AC power supply to the motor 34 via the power cord 22, or communicates an external “DC” power supply to the motor 34 via terminals. It is also envisioned within the present invention that a portable battery supply can be installed or attached to the body, however an advantage associated with the power cord in combination with the positioning of the motor 34 is the low center of gravity achieved by the device and which is a function of positioning the motor 34 at a location and position proximate to a bottom center line of the housing, and as will be further explained in additional detail.

Secured to an opposite surface of the motor supported mounting plate is a planetary drive gear system and which communicates a rotatable output of the motor 34 to a closed and continuously driven cutting band 42. As best illustrated with reference to FIGS. 1 and 4 in combination, the gear system includes a toothed output shaft 44 (see in particular FIG. 4) associated with the motor 34, a first plurality of driven gears 46, 48, and 50 encircling and meshingly engaged by the toothed output shaft 44.

A ring-shaped gear is exhibited at 52 and includes both inner and outer toothed perimeters. The ring 52 encircles and is meshingly engaged by each of the first plurality of gears 46, 48 and 50 in order to rotate in a specified direction. An exterior surface of the ring-shaped gear 52 meshingly engages each of a second plurality of driven gears 54, 56 and 58 arranged at outer circumferential locations about the ring-shaped gear 52. The gears 54, 56 and 58 are pin mounted to apertures in the motor supporting plate, and such as shown at 60 and 62 in FIG. 3.

A band support gear is meshingly engaged to each of the second driven gears and is represented at 64, 66 and 68, corresponding to gears 54, 56 and 58, and associated with outermost locations of the arcuate extending portions 26, 28 and 32 of the base mounting surface of the coping saw body. Additional outermost apertures, shown representatively at 70, 71 and 72 in FIG. 3, are formed through the motor supported plate, and in order to mount second driven gears 64, 66 and 68 in the manner illustrated.

Each of the three outermost driven gears 64, 66 and 68 operate as a band supporting gear and in order to support the cutting band 42 in extending fashion about the lower periphery of the body. In particular, and as is best illustrated in the exploded view of FIG. 3, each of the gears 64, 66 and 68 include an intermediate annular side channel, see as represented for example at 75 for gear 66, and in order to support the cutting band 42.

A fourth outermost located roller, see at 73 and which corresponds to arcuate portion 28 of the body, is arranged in freely rotatable fashion (as opposed to the other three gear driven supports 64, 66 and 68). The roller 73 includes a cutting band support recess for securing the cutting band 42 at a fourth perimeter extending location and such that the said cutting band exhibits a substantially four-sided configuration about the gear system and is supported in friction fit fashion within the band support gears.

The freely rotatable band support roller 73 includes a quick release lever 74, which permits the roller 73 to be translated between an outermost displaced and band tensioning position and an inwardly displaced and band relaxed position. This is accomplished by a support pin 77 associated with the free rotating roller 73 and which seats in translating fashion along a slot 79 defined in the motor mounted support surface associated with the roller.

The lever 74, as shown in FIG. 4, is rotated between engaged 74′ and release 74 positions and such that roller 73 may be inwardly displaced to relax tension on the perimeter mounted band 42 and to permit replacement or repositioning of the same. The band 42 is typically friction fit about the gear driven members 64, 66 and 68 and freely rotatable roller 73, however it is also envisioned that a suitably configured cutting band can include a toothed inner array to mechanically slave the same to corresponding outer toothed surfaces associated with the outermost perimeter extending rollers and in continuous traveling fashion. It is also envisioned that the gear drive system for operating the cutting band may include either a lesser or greater number of drive gears supporting the cutting band and relative to a corresponding lesser or greater number of freely rotatable support rollers.

A bottom cap is provided and includes four arcuate extending portions 76, 78, 80 and 82 and which correspond in mating alignment with the likewise arcuate portions associated with the housing base and attachable base plate supporting both the motor 34 and planetary gear drive system. The bottom cap corresponds in shape and configuration with the base surface and seats the mounting plate in sandwiched fashion therebetween.

The bottom cap further includes a plurality of depthwise extending and arcuately configured sidewalls, a plurality of gaps existing between the sidewalls and defining pathways for permitting the blade to traverse in and out of the assembled housing. In particular, and referencing again FIG. 3, associated arcuate sidewalls are shown at 84, 86, 88, et seq., and which establish therebetween likewise arcuate extending pathways 90, 92, et seq.

In this fashion, the cutting band 42 defines a substantially four-sided configuration about the gear system and creates a plurality of four cutting zones, represented generally at 94, 96, 98 and 100 in FIG. 4, each cutting zone corresponding to an area extending from a selected, substantially linear, side of the cutting band and an associated arcuate side extending surface of the body. Another term for cutting zone is a cutting throat and which generally defines that gap or clearance which is available for receiving and sectioning a portion of an inserted workpiece, i.e., trim or baseboard molding or the like and as is referenced in FIG. 2. The arrangement of the arcuate throat further provides the advantage of permitting a high degree of repositioning/manipulation of the tool and in order to achieve a high degree of precision in the cut of the workpiece.

As is again illustrated in FIG. 3, the bottom cap (which is easily engaged and disengaged to hold the motor and mounting plate within the housing body) includes an inwardly folded portion, see at 102, along a given side (and corresponding to a cutting zone over which the power cord 22 extends). The fold over portion 102 operates as a cover for the cutting blade along the associated throat, or cutting zone, and in order to help insure against damage to power cord 24 or injury to the user's hand. It is also envisioned that additional fold over portions may be provided for corresponding cutting zones (such as two or three) among the four indicated by the generally four-sided saw. It is also envisioned that other cutting configurations, such as associated with a three-sided saw, are contemplated with the scope of one of ordinary skill in the art.

Having described our invention, other and additional preferred embodiments will become apparent to those skilled in the art. Specifically, the planetary gear arrangement can be redesigned with other possible arrangements of driven or spur gears. Also, it is envisioned that the drive arrangement for the cutting band can be redesigned, along with the body of the tool, and in order to achieve a triangular or other multisided configuration.

We claim:

1. A power saw suitable for one-handed operation, comprising:
a body enclosing an electric motor, a power supply communicated to said motor;
a continuous cutting band mounted within said body and projecting from at least one arcuately configured exterior surface associated with said body, a cutting zone being established between said cutting band and said body; and
said band being operatively driven through a gear arrangement connected to an output of said motor in order to perform a ripping operation on a workpiece positioned within said cutting zone.

2. The power saw as described in claim 1, said body further comprising a palm-shaped grip, a power cord extending from said grip and in a direction away from said cutting zone.

3. The power saw as described in claim 2, said grip further comprising an ergonomic, non-slip rubber surface.

4. The power saw as described in claim 2, further comprising an adjustable strap extending above said palm-shaped grip.

5. The power saw as described in claim 1, said body exhibiting a specified shape and size, said motor being positioned within said body at a height and location approximate a center point defined by said cutting band.

6. The power saw as described in claim 1, further comprising a plurality of cutting zones established along individual side extending locations associated with said body.

7. The power saw as described in claim 1, further comprising a planetary gear system for driving said cutting band.

8. The power saw as described in claim 7, said gear system further comprising:
a toothed output shaft associated with said motor;
a first plurality of driven gears encircling and meshingly engaged by said output shaft;
a ring-shaped gear encircling and meshingly engaged by said first plurality of gears to rotate in a specified direction;
an exterior surface of said ring-shaped gear meshingly engaging each of a second plurality of driven gears arranged at outer circumferential locations about said ring-shaped gear; and
a band support gear meshingly engaging each of said second driven gears, said cutting band being supported in linearly translating fashion between said band support gears.

9. The power saw as described in claim 8, said cutting band exhibiting a specified shape and size and being supported in friction fit fashion within said band support gears.

10. The power saw as described in claim 8, said cutting band defining a substantially four-sided configuration about said gear system, a plurality of cutting zones corresponding to said sides of said cutting band.

11. The power saw as described in claim 10, said body further comprising a housing incorporating a palm-shaped grip, an extending intermediate section, and a base having a specified depth and a multi-sided exterior configuration.

12. The power saw as described in claim 11, said motor being supported upon a mounting plate, against a reverse face of which is secured said planetary gear system, said mounting plate matingly securing within said base and, in combination defining a plurality of side extending and arcuately configured recesses across which said cutting band traverses.

13. The power saw as described in claim 12, further comprising a bottom cap corresponding in shape and configuration with said base surface and seating said mounting plate in sandwiched fashion therebetween.

14. The power saw as described in claim 8, further comprising a freely rotatable band support roller, a quick release lever permitting said roller to be translated between an outermost displaced and band tensioning position and an inwardly displaced and band relaxed position.

15. The power saw as described in claim 14, further comprising a support pin associated with said roller translating along a slot defined in a support surface associated with said roller.

16. The power saw as described in claim 1, further comprising a variable switch accessible from said body and modifying an operating speed of said motor.

17. The power saw as described in claim 13, said bottom cap further comprising an inwardly folded portion for enclosing said cutting band along a selected cutting zone.

18. The power saw as described in claim 13, said bottom cap further comprising a plurality of depthwise extending and arcuately configured sidewalls, a plurality of gaps between said sidewalls defining pathways for said blade band across said cutting zones.

19. A power saw suitable for one-handed operation, comprising:
a three-dimensional shaped body having a hand grip and a base defining multi-sided exterior configuration;
an electric motor supported upon a mounting plate and installed within said housing, a gear drive system extending from an exposed face of said mounting plate, a power supply communicated to said motor and operatively driving said gear system;
a continuous cutting band supported upon outermost projecting gear members associated with said gear drive system such that said band projects from a plurality of arcuately configured exterior surfaces associated with said body, a cutting zone being established at each projecting location of said band to perform a ripping operation on a workpiece positioned within a selected cutting zone.

20. A power saw suitable for one-handed operation, comprising:
a body enclosing an electric motor, a power supply communicated to said motor;
a continuous cutting band mounted within said body and in projecting fashion from a plurality of arcuately configured and exterior surface locations associated with an outer perimeter said body, a cutting zone being established between said cutting band and each projecting location; and
said band being operatively driven through a gear arrangement connected to an output of said motor in order to perform a ripping operation on a workpiece positioned within said cutting zone.
